(19) United States
(12) Patent Application Publication
(10) Pub. No.: US 2006/0202052 A1
(43) Pub. Date: Sep. 14, 2006

(54) Fuel injection valve comprising two coaxial valve needles

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/544,719

(22) PCT Filed: Oct. 8, 2003
(86) PCT No.: PCT/DE03/03330

§ 371 Date: Aug. 5, 2005

(30) Foreign Application Priority Data
Feb. 5, 2003 (DE) 1 03 04 605.4

(51) Int. Cl. F02M 47/02; F02M 43/00; F02M 61/00

(52) U.S. Cl. 239/88; 239/533.3

(57) ABSTRACT

A fuel injection valve for internal combustion engines, having an outer valve needle and an inner valve needle guided therein, in which the outer valve needle and the inner valve needle can be actuated independently of one another. In an especially preferred embodiment, the course of injection of the inner nozzle needle can be shaped within wide limits by means of a third outlet throttle restriction.

### PRIOR ART

The invention is based on a fuel injection valve for internal combustion engines as generically defined by the preamble to claim 1. One such fuel injection valve is known for instance from German Patent Disclosure DE 102 05 970 of the present applicant, which was not yet published by the priority date of the present application.

In a housing, there are an outer valve needle and an inner valve needle guided in the outer valve needle. Both valve needles cooperate, by their end toward the combustion chamber, with a valve seat face in which two rows of injection openings are embodied. The outer row of injection openings is controlled by the outer valve needle, and the inner row of injection openings is correspondingly controlled by the inner valve needle. Through a high-pressure conduit embodied in the housing, fuel is delivered to the injection openings at high pressure; controlled by the valve needles, it emerges through the injection openings and is injected from there into the combustion chamber of the internal combustion engine. The control of the outer valve needle and the control of the inner valve needle are not independent of one another.

### ADVANTAGES OF THE INVENTION

The fuel injection valve of the invention having the definitive characteristics of claim 1 has the advantage over the prior art that the inner and outer valve needles can be triggered in a way completely decoupled from one another. As a result, the possibilities for adapting the mode of operation of the fuel injection valve optimally to various internal combustion engines exists, so that during operation, improved operation and emissions of the engine are attained.

In an especially advantageous variant of the fuel injection valve of the invention, the control chamber can be made to communicate with the pressureless leak fuel chamber by means of a third outlet throttle restriction, the third outlet throttle restriction being closable by the control valve. By this provision, the injection course of the inner valve needle can be shaped within a wide range, which also has a positive effect on the operation of the engine. This also makes it easier to meter extremely small preinjection quantities. It is understood that instead of the inner valve needle, the outer valve needle may be controlled with an additional third outlet throttle restriction, or its injection course shaped thereby.

In this configuration, it has proved positive if the control valve is embodied as a 4/3-way control valve.

In an advantageous feature of the subject of the invention, the control valve has a valve chamber, communicating with the control chamber, and a valve member, which is controlled by an actuator. The actuator is preferably embodied as an electric actuator and in particular as a piezoelectric actuator. As a result, the valve member can be controlled precisely, and the valve member can move directly to the desired position.

In a further advantageous feature, the valve member cooperates, in a first switching position, with a first valve seat and, in a second switching position, with a second valve seat, and the valve chamber is sealed off from the leak fuel chamber in the first switching position and communicates with the leak fuel chamber in the second switching position. By means of this valve member, the pressure in the control chamber and in the control pressure chamber can be controlled precisely and without any significant delay.

In a further advantageous feature, the control valve, in its second switching position, closes the third outlet throttle restriction while the first and second outlet throttle restrictions are opened. In addition, the valve member can also be put into a third switching position, in which all three outlet throttle restrictions are opened, so that the third outlet throttle restriction is in operation only as needed.

In a further advantageous feature, an outer pressure piston is located in the housing and is connected to the outlet throttle restriction, and its end face defines the control chamber. In this way, a hydraulic force from the pressure in the control chamber is exerted on the end face of the outer pressure piston, so that a closing force is exerted on the outer valve needle.

Because of the separation of the function of the pressure face acted upon by pressure and the valve needle, these two parts can be optimized separately from one another.

In a further advantageous feature, the outer pressure piston, in the opening stroke motion of the outer valve needle, comes to rest on a wall of the control chamber, so that the communication of the control chamber with the high-pressure conduit is interrupted. As a result, when the fuel injection valve is open, fuel no longer flows into the control chamber, so that the leak fuel losses of the fuel injection valve are minimized.

In an advantageous feature, in the leak fuel chamber, a pressure that is markedly lower than the injection pressure prevails, preferably atmospheric pressure. The lower the pressure in the leak fuel chamber, the greater are the pressure differences from the injection pressure, so that correspondingly greater forces on the inner and outer valve needles, and hence shorter switching times, can be implemented.

In further advantageous features of the invention, it is provided that both the inner and the outer valve needle are triggerable via only a single control valve. In the housing, a control chamber is embodied that communicates with the high-pressure conduit and furthermore with a control pressure chamber. By means of the pressure in the control chamber, a closing force is exerted at least indirectly on the outer valve needle. In the housing, a control valve is embodied by which the control chamber can be made to communicate with a leak fuel chamber, so that the pressure in the control chamber and, because of the communication with the control chamber, in the control pressure chamber as well can be lowered by way of the control valve to markedly below the injection pressure, so that the closing force on the inner and the outer valve needles can be controlled. Via a suitable switching characteristic of the control valve and by means of suitably dimensioned inflows and outflows of the control chamber and its communication with the control pressure chamber, a separate triggering of the outer valve needle or selectively of both valve needles can be attained.

Further advantages and advantageous features of the subject of the invention can be learned from the drawing and the description.

### DRAWING

One exemplary embodiment of the fuel injection valve of the invention is shown in the drawing. Shown are

FIG. 1, a longitudinal section through a fuel injection valve of the invention, in its essential region;

FIG. 2, an enlargement of FIG. 1 in the region of the end of the injection valve toward the combustion chamber, this detail being marked II in FIG. 1;

FIG. 3, an enlargement of FIG. 1 in the region marked III; and

FIG. 4, a schematic illustration of a fuel injection valve of the invention in an internal combustion engine.

### DESCRIPTION OF THE EXEMPLARY EMBODIMENT

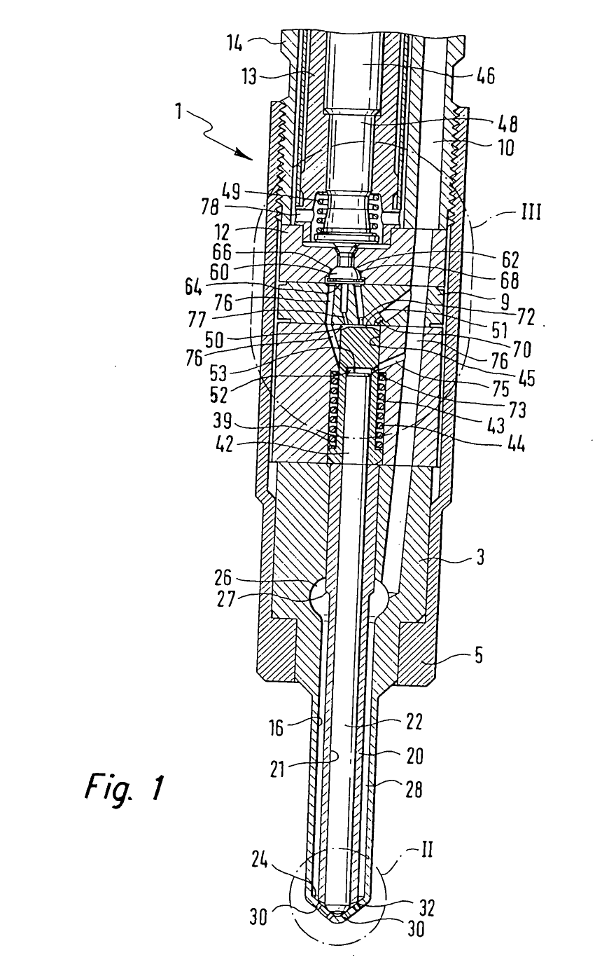

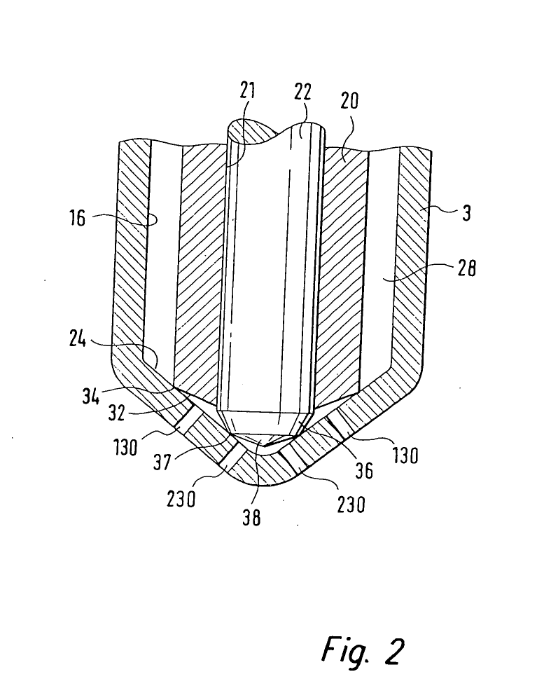

In FIG. 1, a longitudinal section through a fuel injection valve of the invention is shown. The fuel injection valve has a housing 1, which includes a valve body 3, an intermediate body 7, an intermediate disk 9, a control body 12, and a holding body 14; these components contact one another in the order listed. All of these parts of the housing 1 are pressed against one another by their contact faces by means of a lock nut 5. A high-pressure bore 10 is embodied in the housing 1; on one end, it communicates with a high-pressure fuel source, not shown in the drawing, and extends through the holding body 14, the control body 12, the intermediate disk 9, and the intermediate body 7 to the inside of the valve body 3. In the valve body 3, the high-pressure bore 10 discharges into a pressure chamber 26, which is embodied as a radial widening of a bore 16 embodied in the valve body 3. The bore 16 is closed, on its end toward the combustion chamber, by a seat face 24, and injection openings 30 which connect the bore 16 with the combustion chamber of the engine are embodied in the seat face 24. A pistonlike outer valve needle 20 is located in the bore 16 and is guided sealingly in a portion of the bore 16 facing away from the combustion chamber. The outer valve needle 20 tapers, beginning at the guided portion, toward the combustion chamber, forming a pressure shoulder 27, and on its end toward the combustion chamber it changes over into a valve sealing face 32, with which it rests on the seat face 24 in the closing position. In FIG. 2, an enlargement of the detail of FIG. 1 marked II is shown, that is, the region of the seat face 24.

Between the outer valve needle 20 and the wall of the bore 16, an annular conduit 28 is embodied, which connects the pressure chamber 26 with the seat face 24, and the pressure shoulder 27 is located at the level of the pressure chamber 26. In the closing position, the outer valve needle 20 closes off the injection openings 30 from the fuel in the annular conduit 28, so that only when the outer valve needle 20 has lifted from the seat face 24 can fuel flow to the injection openings 30.

The outer valve needle 20 is embodied as a hollow needle and has a longitudinal bore 21. An inner valve needle 22 is located longitudinally displaceably in the longitudinal bore 21 and likewise comes to rest, with its end toward the combustion chamber, in the closing position on the seat face 24.

The injection openings 30 in the seat face 24 are grouped into an outer row 130 and an inner row 230 of injection openings. The outer valve needle 20, on its end toward the combustion chamber, has a conical valve sealing face 32, which has a larger opening angle than the likewise conically embodied seat face 24. As a result, a sealing edge 34 is embodied on the outer edge of the sealing face 32, and in the closing position of the outer valve needle 20 it comes to rest on the seat face 24. The sealing edge 34 is located upstream of the outer row 130 of injection openings, so that upon contact of the sealing edge 34 with the seat face 24, the injection openings of the outer row 130 of injection openings are sealed off from the annular conduit 28. On the end toward the combustion chamber of the inner valve needle 22, there is a conical sealing face 36, which in turn borders on a likewise conical cone face 38, which forms the end of the inner valve needle 22. At the transition from the pressure face 36 to the conical face 38, a sealing edge 37 is embodied, which in the closing position of the inner valve needle 22 comes to rest on the seat face 24. The contact of the sealing edge 37 takes place here between the outer row 130 and the inner row 230 of injection openings, so that upon contact of the inner valve needle 22 with the seat face 24, only the inner row 230 of injection openings is sealed off from the annular chamber 28, but the outer row 130 of injection openings is not sealed off from it.

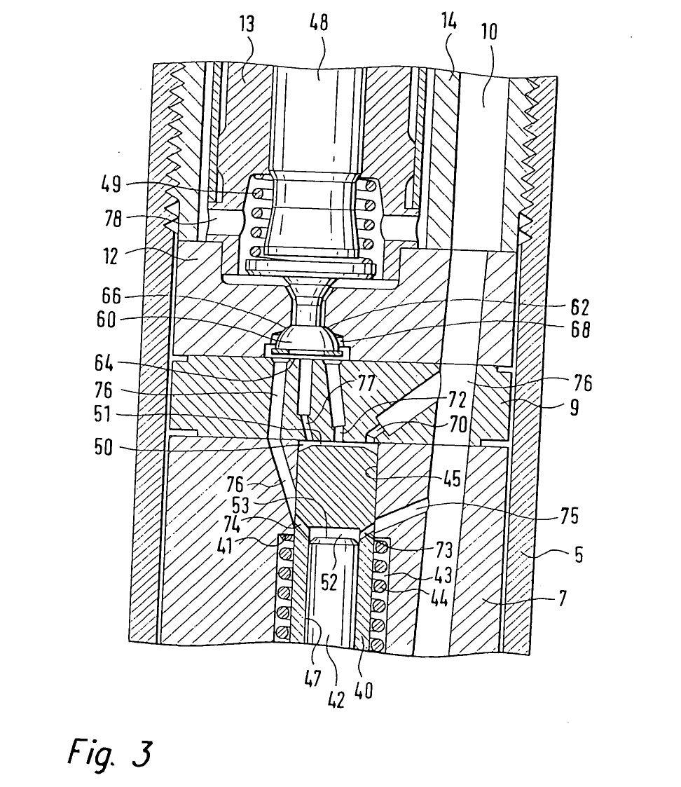

FIG. 3 shows an enlargement of FIG. I in the detail marked III, that is, in the region of the intermediate body 7, intermediate disk 9, and control body 12. In the intermediate body 7, there is a piston bore 45, in which a pressure piston 40 is located that rests with its end toward the combustion chamber on the outer valve needle 20 (see FIG. 1). By means of a radial widening of the piston bore 45, a spring chamber 43 is embodied, in which a closing spring 44 is located with pressure prestressing between a contact face 41 of the spring chamber 43 and an annular face 39 of the outer pressure piston 40; this closing spring surrounds the outer pressure piston 40 over a portion of its length. Because of the prestressing of the closing spring 44, the outer pressure piston 40 is pressed in the direction of the valve body 3 and thus the outer valve needle 20 is also pressed in the direction of the seat face 24. A guide bore 47 is embodied in the longitudinal direction in the outer pressure piston 40, and an inner pressure piston 42 is guided in the outer pressure piston and rests with its end toward the combustion chamber on the inner valve needle 22. The inner pressure piston 42 is longitudinally displaceable in the outer pressure piston 40 and moves synchronously with the inner valve needle 22. Alternatively, the inner pressure piston 42 and the inner valve needle 22 may be embodied in a single piece.

The fuel valve 45, the face end 5 1, facing away from the combustion chamber, of the outer pressure piston 40, and the intermediate disk 9 define a control chamber 50. The control chamber 50 communicates with the high-pressure bore 10 via a first inlet throttle restriction 70 and with a valve chamber 68, embodied in the control body 12, via a first outlet throttle restriction 72.

A control pressure chamber 52 is embodied in the outer pressure piston 40 and is defined by the guide bore 47 and by the face end 53, facing away from the combustion chamber, of the inner pressure piston 42. The control pressure chamber 52 communicates with the high-pressure conduit 10 via a second inlet throttle restriction 73 and with the valve chamber 68 via a second outlet throttle restriction 74. In the exemplary embodiment shown in FIG. 3, the second inlet throttle restriction 73 and the second outlet throttle restriction 74 are embodied in the outer pressure piston 40. The communication between the second inlet throttle restriction 73 and the high-pressure bore 10 is made by means of a first connecting bore 75 in the intermediate body 7. The communication between the second outlet throttle restriction 74 and the valve chamber 68 is made by a second connecting bore 76 in the intermediate body 7 and in the intermediate disk 9.

It is understood that the second inlet throttle restriction 73 and the second outlet throttle restriction 74 need not be located in the outer pressure piston 40 but instead can be located in the first connecting bore 75 or in the second connecting bore 76. What is important is that the hydraulic communication between the high-pressure bore 10 and the valve chamber 68, on the one hand, and the pressure control chamber 52 on the other is independent of the position of the outer pressure piston 40. This can be assured by means of suitably selected bore diameters.

Parallel to the first outlet throttle restriction 72, a third outlet throttle restriction 77 is provided in the intermediate disk 9 and likewise makes a hydraulic communication between the control chamber 50 and the valve chamber 68.

A valve member 60 is located in the valve chamber 68; it is embodied essentially in the shape of a hemisphere and forms a control valve 58. The flattened side faces toward the intermediate disk 9, while the hemispherical side of the valve member 60 is connected to a pressure piece 48, which is guided in a receiving body 13 located in the holding body 14. The pressure piece 48 is longitudinally displaceable by an actuator 46 and as a result also moves the valve member 60 in the valve chamber 68; the actuator is embodied for instance as a piezoelectric actuator. The pressure piece 48 is surrounded by a leak fuel chamber 78, which because of its communication with a leak fuel system, not shown in the drawing, always has a low pressure. Facing away from the intermediate disk 9, a first valve seat 62 is embodied in the valve chamber 68, on which valve seat the valve member 60 can come to rest with its spherical valve sealing face 66. Diametrically opposite the first valve seat 62 in the valve chamber 68, a second valve seat 64 is embodied, on which the valve member 60 can come to rest with its flattened side. By the contact of the valve member 60 with the second valve seat 64, the third outlet throttle restriction 77 is closed.

The function of the fuel injection valve is as follows:

At the onset of the injection cycle, the fuel injection valve is in the closing position; that is, both the outer valve needle 20 and the inner valve needle 22 are in contact with the seat face 24 and close both the inner row 230 and the outer row 130 of injection openings (see FIG. 1). Since the valve member 60 is resting on the first valve seat 62, both the control chamber 50, via the first inlet throttle restriction 70, and the control pressure chamber 52, via the second inlet throttle restriction 73, communicate with the high-pressure bore 10, so that both in the control chamber 50 and in the control pressure chamber 52, the high fuel pressure of the high-pressure conduit 10 prevails, which is equivalent to the injection pressure.

The face end 51 of the outer pressure piston 40 has a larger hydraulically operative surface area than the pressure shoulder 27 of the outer valve needle 20, so that the outer valve needle 20 remains in the closing position. The force of the closing spring 44 plays only a subordinate role here; the closing spring 44 serves primarily to keep the outer valve needle 20 in the closing position when the engine is not in operation. In the valve chamber 68 as well, the same pressure prevails, via the first outlet throttle restriction 72, the second outlet throttle restriction 74, and the third outlet throttle restriction 77, as in the high-pressure bore 10. In the leak fuel chamber 78, conversely, a low pressure prevails, which as a rule is approximately equivalent to the atmospheric pressure.

If an injection is to take place, the actuator 46 is actuated, and the valve member 60 moves together with the pressure piece 48 away from the first valve seat 62 to the second valve seat 64. As a result, the valve chamber 68 is made to communicate with the leak fuel chamber 78, so that both the valve chamber 68 and the control chamber 50, via the first outlet throttle restriction 72, and the control pressure chamber 52 as well, via the second outlet throttle restriction 74, are pressure-relieved. By means of the contact of the valve member 60 with the second valve seat 64, the third outlet throttle restriction 77 is closed.

The first inlet throttle restriction 70 and the first outlet throttle restriction 72 are dimensioned such that the pressure in the control chamber 50 does drop, but not down to the level of the leak fuel chamber 78. Because of the drop in pressure in the control chamber 50, the hydraulic force on the face end 51 of the outer pressure piston 40 also decreases, so that now the hydraulic force on the pressure shoulder 27 predominates. The outer valve needle 20 thereupon lifts away from the seat face 24, and fuel flows out of the annular chamber 28 to the outer row 130 of injection openings, and from there it is injected into the combustion chamber of the engine. The outer valve needle 20 and the outer pressure piston 40 move away from the combustion chamber, until the face end 51 of the outer pressure piston 40 comes to rest on the intermediate disk 9.

In the control pressure chamber 52 as well, the pressure drops because of the opening of the control valve 58. Simultaneously, by the lifting of the outer valve needle 20, the pressure face 36 of the inner valve needle 22 as well is now acted on by fuel. As soon as the hydraulic force acting on the pressure face 36 is greater than that on the face end 53 of the inner pressure piston 42, the inner valve needle 22 lifts from the seat face and uncovers the inner row 230 of injection openings.

By a suitable adaptation of the first inlet throttle restriction 70 and first outlet throttle restriction 72, on the one hand, and of the second inlet throttle restriction 73 and second outlet throttle restriction 74 on the other, it is attained that the outer valve needle 20 and the inner valve needle 22 open in a chronologically staggered fashion.

If it is intended, for instance for a pilot injection, that only the outer row 130 of injection openings is to inject fuel into the combustion chamber of the engine, then the valve member 60 must be moved again by the actuator 46, so that the communication of the valve chamber 68 with the leak fuel chamber 78 is interrupted, before the inner valve needle 22 opens. Because of the closure of the control valve 58, a high fuel pressure level builds up again in the control chamber 50 and in the control pressure chamber 52 and pushes the outer pressure piston 40 and thus also the outer valve needle 20 back into the closing position. This is appropriate for instance in a preinjection.

Conversely, if an especially fast pressure reduction in the control chamber 50 and hence an especially fast opening of the outer valve needle 20 are wanted, then the valve member 60 is put in a third switching position, in which it contacts neither the first valve seat 62 nor the second valve seat 64, so that the third outlet throttle restriction 77 also contributes to the pressure reduction in the control chamber 50. Thus by the selective use of the third outlet throttle restriction 77, a shaping of the injection course can be done, which has a positive effect on the operating performance of the engine.

In this exemplary embodiment, the actuator 46 is preferably a piezoelectric actuator. The valve member 60 in the valve chamber 68 requires only a short stroke for its function, of the kind that can as a rule be brought to bear by a piezoelectric actuator. If necessary, a hydraulic booster may be provided, with which longer strokes can be implemented, and which is well known from the prior art. Moreover, piezoelectric actuators offer the advantage that they can switch extremely fast. It is thus possible without problems, in the manner described above, to perform a precise preinjection through only the outer row 130 of injection openings.

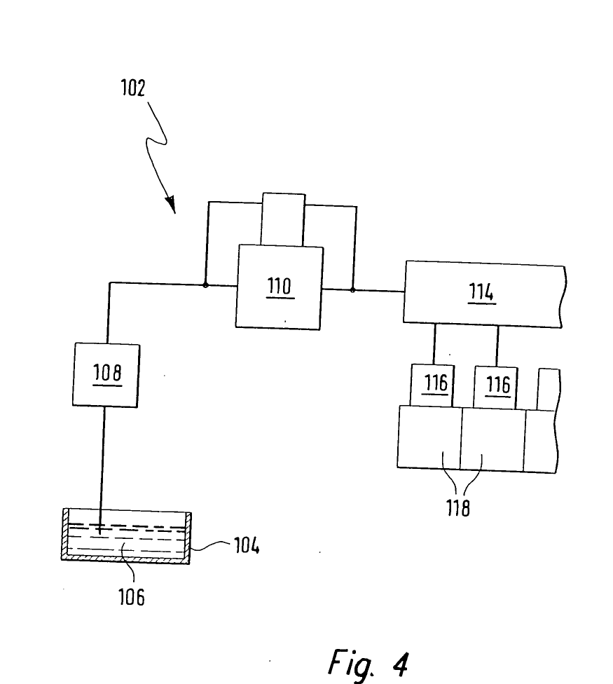

In FIG. 4, a fuel system 102 is shown. This fuel system includes a fuel tank 104, from which fuel 106 is pumped by an electric fuel pump 108. From a high-pressure fuel pump 110, the fuel 106, via a common rail 114, reaches the fuel valves 116 of the invention, which inject the fuel 106 into the combustion chambers 118 of an internal combustion engine in the manner described above.

1-15. (canceled)

16. A fuel injection valve for internal combustion engines, the fuel injection valve comprising,
a housing (1),
a high pressure conduit (10) in the housing (1),
an outer valve needle (20) and an inner valve needle (22) guided in the outer valve needle (20),
a fuel-filled control pressure chamber (52), whose pressure is controllable and by whose pressure, at least indirectly, a closing force is exerted on the inner valve needle (22),
a fuel-filled control chamber (50) embodied in the housing (1) by whose pressure, at least indirectly, a closing force is exerted on the outer valve needle (20),
a first inlet throttle restriction (70), by which the control chamber (50) is made to communicate with the high-pressure conduit (10),
a first outlet throttle restriction (72), by way of which the control chamber (50) can be made to communicate with a pressureless leak fuel chamber (78),
a closable control valve (58) operable to close the first outlet throttle restriction (72)
a second inlet throttle restriction (73) located between the control pressure chamber (52) and the high-pressure conduit (10), and
a second outlet throttle restriction (74) providing communication between the control pressure chamber (52) and the pressureless leak fuel chamber (78),
the second outlet throttle restriction (74) being closable by the control valve (58).

17. The fuel injection valve according to claim 16, wherein the control chamber (50) can be made to communicate with the pressureless leak fuel chamber (78) by means of a third outlet throttle restriction (77), the third outlet throttle restriction (77) being closable by the control valve (58).

18. The fuel injection valve according to claim 17, wherein the control valve (58) is embodied as a 4/3-way control valve.

19. The fuel injection valve according to claim 17, wherein the control valve (58) comprises a valve chamber (68) communicating with the control chamber (50), a valve member (60), and an actuator (46) operable to control the valve member (60).

20. The fuel injection valve according to claim 18, wherein the control valve (58) comprises a valve chamber (68) communicating with the control chamber (50), a valve member (60), and an actuator (46) operable to control the valve member (60).

21. The fuel injection valve according to claim 19, wherein the valve member (60) of the control valve (58) is moved by an electric actuator (46).

22. The fuel injection valve according to claim 21, wherein the electric actuator (46) is a piezoelectric actuator.

23. The fuel injection valve according to claim 19, wherein the valve member (60) cooperates, in a first switching position, with a first valve seat (62) and, in a second switching position, with a second valve seat (64), and the valve chamber (68) is sealed off from the leak fuel chamber (78) in the first switching position and communicates with the leak fuel chamber (78) in the second switching position.

24. The fuel injection valve according to claim 23, wherein the valve member (60), upon its contact with the second valve seat (64), closes the third outlet throttle restriction (77), while the first outlet throttle restriction (72) and the second outlet throttle restriction (74) are opened.

25. The fuel injection valve according to claim 23, wherein the valve member (60) can be put into a middle position, so that the valve member (60) is in contact with neither the first valve seat (62) nor the second valve seat (64).

26. The fuel injection valve according to claim 24, wherein the valve member (60) can be put into a middle position, so that the valve member (60) is in contact with neither the first valve seat (62) nor the second valve seat (64).

27. The fuel injection valve according to claim 16, further comprising an outer pressure piston (40) located in the housing (1) and connected to the outer valve needle (20), the pressure piston (40) having an end face (51) defining the control chamber (50), whereby by means of the hydraulic force on this end face (51), a closing force is exerted on the outer valve needle (20).

28. The fuel injection valve according to claim 17, further comprising an outer pressure piston (40) located in the housing (1) and connected to the outer valve needle (20), the pressure piston (40) having an end face (51) defining the control chamber (50), whereby by means of the hydraulic force on this end face (51), a closing force is exerted on the outer valve needle (20).

29. The fuel injection valve according to claim 19, further comprising an outer pressure piston (40) located in the housing (1) and connected to the outer valve needle (20), the pressure piston (40) having an end face (51) defining the control chamber (50), whereby by means of the hydraulic force on this end face (51), a closing force is exerted on the outer valve needle (20).

30. The fuel injection valve according to claim 22, further comprising an outer pressure piston (40) located in the housing (1) and connected to the outer valve needle (20), the pressure piston (40) having an end face (51) defining the control chamber (50), whereby by means of the hydraulic force on this end face (51), a closing force is exerted on the outer valve needle (20).

31. The fuel injection valve according to claim 27, wherein the outer pressure piston (40) comes to rest on one wall of the control chamber (50) in the opening motion of the outer valve needle (20) and as a result interrupts the first inlet throttle restriction (70), which connects the control chamber (50) with the high-pressure conduit (10).

32. The fuel injection valve according to claim 27, wherein the control pressure chamber (52) is embodied in the outer pressure piston (40).

33. The fuel injection valve according to claim 16, wherein, in the leak fuel chamber (78), a pressure that is markedly lower than the injection pressure always prevails, preferably atmospheric pressure.

34. The fuel injection valve according to claim 16, wherein the outer valve needle (20) is guided in a bore (16) of the housing (1); and wherein the inner valve needle (22) is guided in the outer valve needle (20), and the outer valve needle (20), in a closing position, comes to rest on a valve seat (24) located on the end of the housing (1) toward the combustion chamber and, by means of a longitudinal motion in an opening direction, opens an outer row (130) of injection openings, and the inner valve needle (22) likewise resting on the valve seat (24) in a closing position and by a longitudinal motion in an opening direction opens an inner row (230) of injection openings, to which rows (130; 230) of injection openings, in the opened state of the valve needles (20; 22), fuel flows under pressure out of a pressure chamber (26) embodied in the housing (1) and from there is injected into the combustion chamber of the engine.

35. The fuel injection valve according to claim 34, further comprising a pressure shoulder (27) embodied on the outer valve needle (20), which pressure shoulder is acted upon by the fuel pressure in the pressure chamber (26), so that as a result, a force acting in the opening direction is produced upon the outer valve needle (20), and a pressure face (36) on the inner valve needle (22), which after the outer valve needle (20) has lifted from the valve seat (24) is urged in the opening direction by the fuel pressure.
